(19) United States
(12) Patent Application Publication
(10) Pub. No.: US 2017/0050309 A1
(43) Pub. Date: Feb. 23, 2017

(54) Object Retrieval Device

(71) Applicant: Jack Livera, Oxford, NJ (US)

(72) Inventor: Jack Livera, Oxford, NJ (US)

(21) Appl. No.: 15/239,793

(22) Filed: Aug. 17, 2016

Related U.S. Application Data
(60) Provisional application No. 62/205,993, filed on Aug. 17, 2015.

(51) Int. Cl. B25J 1/04; B25B 9/04; B25B 7/12

(52) U.S. Cl. CPC B25J 1/04; B25B 7/12; B25B 9/04

(57) ABSTRACT

An object retrieval device for retrieving objects is provided. The object retrieval device comprises an elongated hollow housing having a first end and a second end. A grab hook is attached to the second end of the housing with the grab hook having an inner curved surface. A rod is slidably mounted within the housing with the rod having a first end and a second end. A handle is mounted to the first end of the rod. A spring mechanism is mounted between the first end of the housing and the handle with the spring mechanism biasing the rod in a general direction away from the grab hook. Upon manipulating the rod to overcome the bias of the spring mechanism, the second end of the rod contacts the inner curved surface of the grab hook thereby releasably securing objects between the second end of the rod and the grab hook.

### CLAIM OF PRIORITY

This patent application claims priority under 35 USC 119 (e) (1) from U.S. Provisional Patent Application Ser. No. 62/205,993 filed Aug. 17, 2015, of common inventorship herewith entitled, “EZ Reach Laundry Buddy,” which is incorporated herein by reference as though the same were set forth in its entirety.

### FIELD OF THE INVENTION

The present invention pertains to the field of limited mobility aids, and more specifically to the field of object retrieval tools.

### BACKGROUND OF THE INVENTION

For most people, household chores are a fact of life. Vacuuming debris from carpeting, polishing furniture, waxing floors and cleaning windows are necessary tasks which are done regularly to ensure a healthy and clean household. In particular, most people wash laundry on a regular basis. Whether tossing a child's dirty baseball uniform into the wash before a big game, laundering bed linens for unexpected company or simply washing soiled bath towels and washcloths for the next day's use, most people utilize a washing machine several times a week. For large families and children, laundry often is washed on a daily basis simply to keep all household members in clean clothing.

Because laundry is perhaps the most necessary of all household chores, a myriad of products make this task easier. Liquid detergents, stain guards, fabric softeners, bleach, hampers, hangers and laundry baskets are a few of the many items consumers utilize while doing their laundry. For many individuals, the simple task of accessing all goods which must be laundered from within the recesses of a deep hamper, washing machine or dryer can be extremely difficult. This retrieval difficulty is especially true for older people who suffer limited mobility or chronic back pain and are unable to comfortably bend over and reach deep into a washing machine's drum or the back of a dryer to access clothing and accessories positioned beyond their arm's reach. People of short stature often experience problems emptying hampers, and loading and unloading their washing machines, causing unnecessary strain and discomfort to themselves in the process.

The prior art has put forth several designs for object retrieval tools. Among these are:

U.S. Pat. No. 8,500,180 to David Buzby and Dinosio Rodriguez describes hand operated portable devices for grasping and manipulation of objects. More specifically, the invention comprises devices for grasping and manipulation of objects by persons with limited physical ability and for grasping and manipulation of objects by unencumbered persons when an object is out of normal reach. Each device comprises a head region having two opposing jaw members with each member having a proximal end which is the end closer to the handle end and closer to the user of the device when it is held by the handle and a distal end which is the end further from the handle. Jaw members are operably attached at a pivot point to a jaw base assembly. Such attachment allows movement of each jaw member around its pivot point.

U.S. Pat. No. 7,958,651 to Allan M. Maniha describes an apparatus for retrieving articles from a dryer or otherwise retrieving articles from places uneasily accessible. The apparatus comprises a handle with a head attached thereto. The head is mounted so as to be detachable, swivelable, or interchangeable. The handle is telescoping in range for further reaching capability or foldable for easy storage. The apparatus provides illumination as well as be configured to reach into small, various shaped, and otherwise uneasy to reach locations.

U.S. Pat. No. 7,344,171 to James McMullan describes a handheld device for gripping objects positioned beyond arm's length, comprising a pair of jaws movable relative to each other between an unclamped position and a fully clamped position. A handle is spaced apart from the jaws by a central portion. The handle includes a trigger connected to the jaws by a pull member, whereby actuation of the trigger is operative to move the jaws between the unclamped and fully clamped positions thereof. A locking mechanism is selectively operable to lock the jaws in at least one intermediate position defined between the unclamped and fully clamped positions. The pull member is sufficiently resilient so as to permit the jaws to be temporarily urged away from each other towards the unclamped position when the pair of jaws are locked in the at least one intermediate position.

None of these prior art references describe the present invention.

### SUMMARY OF THE INVENTION

It is an object of the present invention to provide a cylindrical, elongated tool with a spring loaded sliding rod running lengthwise and a hooking mechanism integrally attached on its distal end for use in grabbing clothing, linens and other articles.

The present invention is an object retrieval device for retrieving objects in washing machines, dryers, hampers, and other hard to reach places. The object retrieval device comprises an elongated hollow housing having a first end and a second end. A grab hook is attached to the second end of the housing with the grab hook having an inner curved surface. A rod is slidably mounted within the housing with the rod having a first end and a second end. A handle is mounted to the first end of the rod. A spring mechanism is mounted between the first end of the housing and the handle with the spring mechanism biasing the rod in a general direction away from the grab hook. Upon manipulating the rod to overcome the bias of the spring mechanism, the second end of the rod contacts the inner curved surface of the grab hook thereby releasably securing objects between the second end of the rod and the grab hook.

In addition, the present invention includes a method for retrieving objects in washing machines, dryers, hampers, and other hard to reach places. The method comprises providing an elongated hollow housing having a first end and a second end, attaching a grab hook to the second end of the housing with the grab hook having an inner curved surface, slidably mounting a rod within the housing with the rod having a first end and a second end, mounting a handle to the first end of the rod, mounting a spring mechanism between the first end of the housing and the handle, biasing the rod in a general direction away from the grab hook, manipulating the rod to overcome the bias of the spring mechanism, contacting the second end of the rod with the inner curved surface of the grab hook, and releasably securing objects between the second end of the rod and the grab hook.

The present invention further includes an object retrieval device for retrieving objects in washing machines, dryers, hampers, and other hard to reach places. The object retrieval device comprises an elongated hollow housing having a first end and a second end. A pair of hand grips are attached nearingly adjacent the first end of the housing. A grab hook is attached to the second end of the housing with the grab hook having an inner curved surface. A rod is slidably mounted within the housing with the rod having a first end and a second end. A T-shaped handle is mounted to the first end of the rod. A spring mechanism is mounted between the first end of the housing and the handle. The spring mechanism biases the rod in a general direction away from the grab hook. Upon manipulating the rod to overcome the bias of the spring mechanism, the second end of the rod contacts the inner curved surface of the grab hook thereby releasably securing objects between the second end of the rod and the grab hook.

### BRIEF DESCRIPTION OF THE DRAWINGS

FIG. 1 is a perspective view illustrating an object retrieval device, constructed in accordance with the present invention, utilizing nonrusting stainless steel spring along with a durable and reliable, heavy duty, plastic construction for a hollow housing, a sliding rod partially extending from the housing, and a distal hook formed on the hollow housing.

FIG. 2 is another perspective view illustrating the object retrieval device, constructed in accordance with the present invention, showing a proximal palm knob secured to the sliding rod, sturdy hand grips formed on the hollow housing, a retracted sliding rod, and the distal hook formed on the hollow housing.

FIG. 3 is a perspective view illustrating a wall mount component of the object retrieval device, constructed in accordance with the present invention, showing protruding hanging hooks and a wall attachment capability by means of screws or adhesive backing.

FIG. 4 is a still another perspective view illustrating the object retrieval device, constructed in accordance with the present invention, showing the proximal palm knob secured to the sliding rod, sturdy hand grips formed on the hollow housing, a magnetic strip for attachment to laundry machine, an extended sliding rod, and a distal hook formed on the hollow housing.

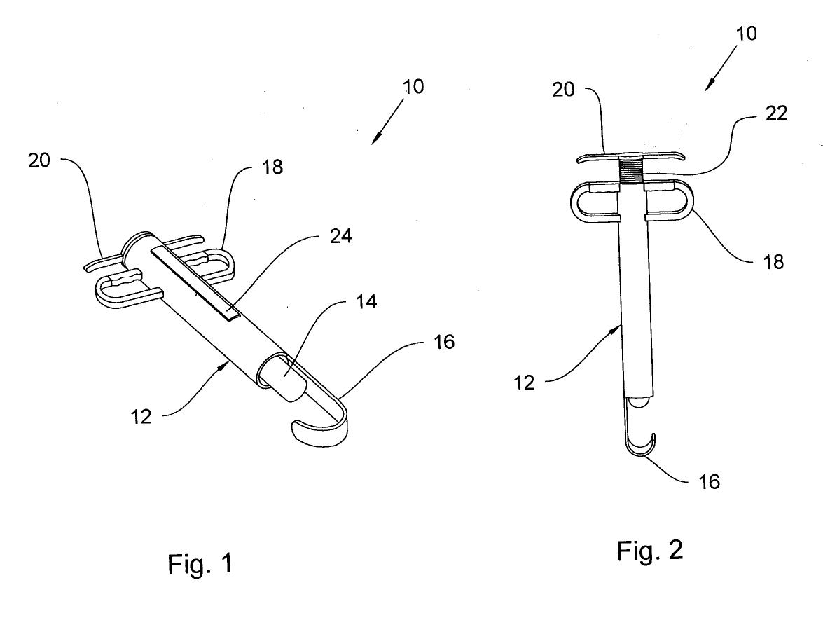

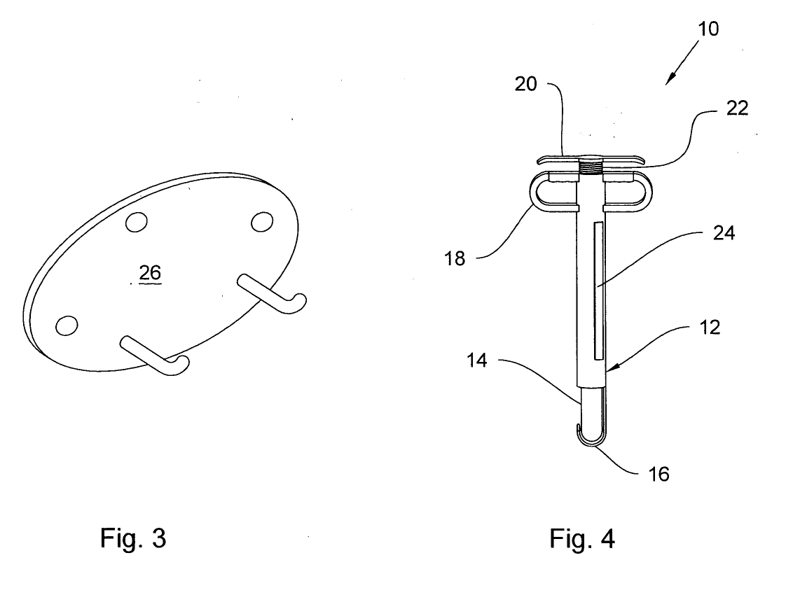

### DETAILED DESCRIPTION OF THE INVENTION

The present invention, hereinafter referred to as the Object Retrieval Device, indicated generally at 10, is a cylindrical, elongated housing 12 with a spring loaded sliding rod 14 running lengthwise and a hook 16 integrally attached on its distal end for use in grabbing clothing, linens and other articles. The Object Retrieval Device 10 provides individuals, particularly those who suffer limited mobility, have chronic back pain or are short in stature, with an easy means of retrieving items that are hard to reach in washing machines, dryers, hampers, and anywhere else. The present invention is configured expressly to enable a user to retrieve clothing and other items while standing upright.

The Object Retrieval Device 10 of the present invention includes an elongated hollow housing 12 having a first end and a second end. A pair of sturdy hand grips 18 can be formed or attached nearingly adjacent the first end of the housing 12 and a distal grab hook 16 can be formed or attached at the second end of the housing 12. Preferably, each hand grip 18 measures approximately four (4″) inches in length. For practical purposes, the surface of the hand grips 18 are preferably coated in grooved rubber or comparable nonskid material to facilitate a firm and comfortable hold during use.

Preferably, the grab hook 16 of the Object Retrieval Device 10 of the present invention curves back over the second end of the housing 12 at least one hundred and eighty (180°) degrees. In a preferred embodiment, the housing 12 is approximately fifteen (15″) inches in length and the grab hook 16 extends approximately two (2″) inches from the second end of the housing 12 although having a housing 12 and/or grab hook 16 with a greater or less length is within the scope of the present invention.

The Object Retrieval Device 10 of the present invention additionally includes a sliding rod 14 slidably mounted within the housing 12. The sliding rod 14 has a first end and a second end with a simple T-shaped palm knob 20 or handle mounted to the first end of the sliding rod 14. The palm knob 20 is sized and shaped for fitting comfortably in the palm of a user's hand.

Mounted between the palm knob 20 of the sliding rod 14 and the first end of the housing 12 of the Object Retrieval Device 10 of the present invention and separating the palm knob 20 from the housing 12 is a spring mechanism 22. The spring mechanism 22 biases the sliding rod 14 in a general direction toward and out the first end of the housing 12. Preferably, the spring mechanism 22 is a stainless steel coil spring although other types of springs are within the scope of the present invention.

In operation, the second end of the sliding rod 14 of the Object Retrieval Device 10 of the present invention is normally flush with the second end of the housing 12 in the retracted position. When the sliding rod 14 overcomes the bias of the spring mechanism 22 by manipulation by the aforementioned T-shaped palm knob 20, the second end of the sliding rod 14 exits the second end of the housing 12 until the second end of the sliding rod 14 rests against the inner curve of the grab hook 16. The grab hook 16, along with the sliding rod 14, is used for grabbing and securing items from the bottom of a hamper or the base or rear of a washer or dryer drum.

Preferably, the housing 12, the sliding rod 14, and the grab hook 16 of the Object Retrieval Device 10 of the present invention are formed from a lightweight, heavy duty plastic material although constructing the housing 12, the sliding rod 14, and the grab hook 16 from a different material is within the scope of the present invention. In addition, the Object Retrieval Device 10 includes a magnetic strip 24 secured along the housing 12 for releasably securing the Object Retrieval Device 10 to a washer or a dryer. Furthermore, the Object Retrieval Device 10 can be accompanied by a wall mount 26 securable to a surface by adhesive or screws allowing the Object Retrieval Device 10 to be stored while not in use.

Using the Object Retrieval Device 10 of the present invention is simple and straightforward. A user holds the Object Retrieval Device 10 by the T-shaped knob inserting two fingers in each loop of the hand grips. The user directs the grab hook at the second end of the housing to hook on an item to be retrieved such as a single sock or a towel. If simply hooking the item to be retrieved is not effective, the user can secure the item to be retrieved by pushing down on the T-shaped palm knob, thereby extending the sliding rod to hold the item against the grab hook deep within the confines of a clothes hamper or washing or drying machine. The user grasps the item by means of the grab hook and releases the palm knob to retract the sliding rod into the housing. The user then pulls back on the Object Retrieval Device 10, easily reaching the once unattainable item. The user repeats the aforementioned process with all clothing, linens, or other laundry goods positioned out of reach. After using the Object Retrieval Device 10, the user stores it away along with other laundry accessories until needed again.

A handheld, spring loaded tool which easily grabs items that are positioned too far away to comfortably reach, the Object Retrieval Device 10 of the present invention helps an individual retrieve items to be laundered while allowing them to comfortably stand upright while doing so. Eliminating the need to painfully bend over and lean into a hamper or laundry drum to grab an elusive sock or dish towel, the Object Retrieval Device 10 enables a user to complete these tasks in a safe and comfortable manner. In addition, using the present invention is particularly helpful for individuals of short stature by readily facilitating the tasks of emptying a hamper and removing clothes from a washing machine or dryer. The Object Retrieval Device 10 is utilized to quickly retrieve items that may have fallen behind or between laundry machines. Durably constructed of heavy duty stainless steel and plastic materials, the Object Retrieval Device 10 will withstand years of repeated use, with ease.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An object retrieval device for retrieving objects in washing machines, dryers, hampers, and other hard to reach places, the object retrieval device comprising:
an elongated hollow housing having a first end and a second end;
a grab hook attached to the second end of the housing, the grab hook having an inner curved surface;
a rod slidably mounted within the housing, the rod having a first end and a second end;
a handle mounted to the first end of the rod; and
a spring mechanism mounted between the first end of the housing and the handle, the spring mechanism biasing the rod in a general direction away from the grab hook;
wherein upon manipulating the rod to overcome the bias of the spring mechanism, the second end of the rod contacts the inner curved surface of the grab hook thereby releasably securing objects between the second end of the rod and the grab hook.

2. The object retrieval device of claim 1 and further comprising:
a pair of hand grips attached nearingly adjacent the first end of the housing.

3. The object retrieval device of claim 2 wherein each of the hand grips are coated in grooved rubber or nonskid material.

4. The object retrieval device of claim 1 wherein the grab hook curves back over the second end of the housing at least one hundred and eighty (180°) degrees.

5. The object retrieval device of claim 1 wherein the handle is a T-shaped palm knob.

6. The object retrieval device of claim 1 wherein the spring mechanism is a stainless steel coil spring.

7. The object retrieval device of claim 1 wherein the second end of the sliding rod is flush with the second end of the housing prior to overcoming the bias of the spring mechanism.

8. The object retrieval device of claim 1 wherein the housing, the sliding rod, and the grab hook are formed from a lightweight, heavy duty plastic material.

9. The object retrieval device of claim 1 and further comprising:
a magnetic strip secured along the housing.

10. The object retrieval device of claim 1 and further comprising:
a wall mount securable to a surface by adhesive or screws.

11. A method for retrieving objects in washing machines, dryers, hampers, and other hard to reach places, the method comprising:
providing an elongated hollow housing having a first end and a second end;
attaching a grab hook to the second end of the housing, the grab hook having an inner curved surface;
slidably mounting a rod within the housing, the rod having a first end and a second end;
mounting a handle to the first end of the rod;
mounting a spring mechanism between the first end of the housing and the handle;
biasing the rod in a general direction away from the grab hook;
manipulating the rod to overcome the bias of the spring mechanism;
contacting the second end of the rod with the inner curved surface of the grab hook; and
releasably securing objects between the second end of the rod and the grab hook.

12. An object retrieval device for retrieving objects in washing machines, dryers, hampers, and other hard to reach places, the object retrieval device comprising:
an elongated hollow housing having a first end and a second end;
a pair of hand grips attached nearingly adjacent the first end of the housing;
a grab hook attached to the second end of the housing, the grab hook having an inner curved surface;
a rod slidably mounted within the housing, the rod having a first end and a second end;
a T-shaped handle mounted to the first end of the rod;
a spring mechanism mounted between the first end of the housing and the handle, the spring mechanism biasing the rod in a general direction away from the grab hook;
wherein upon manipulating the rod to overcome the bias of the spring mechanism, the second end of the rod contacts the inner curved surface of the grab hook thereby releasably securing objects between the second end of the rod and the grab hook.

13. The object retrieval device of claim 12 wherein each of the hand grips are coated in grooved rubber or nonskid material.

14. The object retrieval device of claim 12 wherein the grab hook curves back over the second end of the housing at least one hundred and eighty (180°) degrees.

15. The object retrieval device of claim 12 wherein the handle is a T-shaped palm knob.

16. The object retrieval device of claim 12 wherein the spring mechanism is a stainless steel coil spring.

17. The object retrieval device of claim 12 wherein the second end of the sliding rod is flush with the second end of the housing prior to overcoming the bias of the spring mechanism.

18. The object retrieval device of claim 12 wherein the housing, the sliding rod, and the grab hook are formed from a lightweight, heavy duty plastic material.

19. The object retrieval device of claim 12 and further comprising:
a magnetic strip secured along the housing.

20. The object retrieval device of claim 12 and further comprising:
a wall mount securable to a surface by adhesive or screws.
